(19) United States
(12) Patent Application Publication
(10) Pub. No.: US 2026/0066608 A1
(43) Pub. Date: Mar. 5, 2026

(54) RAMAN AMPLIFICATION SYSTEM, RAMAN AMPLIFICATION METHOD, AND RAMAN AMPLIFIER

(71) Applicant: 1FINITY Inc., Kawasaki-shi (JP)

(72) Inventor: Tomohiro YAMAUCHI, Kawasaki (JP)

(73) Assignee: 1FINITY Inc., Kawasaki-shi (JP)

(21) Appl. No.: 19/319,347

(22) Filed: Sep. 4, 2025

(30) Foreign Application Priority Data
Sep. 5, 2024 (JP) 2024-153246

(51) Int. Cl. H01S 3/091; H01S 3/094; H01S 3/30

(52) U.S. Cl. CPC H01S 3/0912; H01S 3/094096; H01S 3/302

(57) ABSTRACT

A Raman amplification system includes a backward-pumped Raman amplifier provided on an output side of a transmission line and a forward-pumped Raman amplifier provided on an input side of the transmission line, and amplifies a plurality of signal bands by using the backward-pumped Raman amplifier and the forward-pumped Raman amplifier. The backward-pumped Raman amplifier includes a power detector that detects power of at least a part of a signal band on a longest wavelength side among a plurality of signal bands. The forward-pumped Raman amplifier includes a second pumping light source that outputs second pumping light of a specific wavelength for amplifying a second signal band from a shorter wavelength side with highest efficiency among the plurality of signal bands and a second controller that controls the power of the second pumping light source based on a result obtained from the power detector.

### CROSS-REFERENCE TO RELATED APPLICATION

This application is based upon and claims the benefit of priority of the prior Japanese Patent Application No. 2024-153246, filed on Sep. 5, 2024, the entire contents of which are incorporated herein by reference.

### FIELD

A certain aspect of embodiments described herein relates to a Raman amplification system, a Raman amplification method, and a Raman amplifier.

### BACKGROUND

A backward-pumped Raman amplifier is known, which supplies pumping light to a transmission line fiber in a direction opposite to the propagation direction of signal light. A forward-pumped Raman amplifier is also known, which supplies pumping light to the transmission line fiber in a direction same as the propagation direction of signal light.

As the Raman amplifier, for example, a distributed Raman amplifier using a transmission line fiber as an amplifying medium is known. In addition, the wavelength of the pumping light in the distributed Raman amplifier is generally shorter than the wavelength of the signal light (see Japanese Patent Application Publication No. 2009-031796, US Patent Application Publication No. 2019/0020171, Japanese Patent Application Publication No. 2007-028672 and U.S. Pat. No. 7,801,444).

### SUMMARY

According to an aspect of the embodiments, there is provided a Raman amplification system including: a first Raman amplifier of a backward-pumped type, which is provided on an output side of a transmission line; and a second Raman amplifier of a forward-pumped type, which is provided on an input side of the transmission line, wherein the Raman amplification system amplifies a plurality of signal bands by using the first Raman amplifier and the second Raman amplifier, the first Raman amplifier includes a first power detector that detects power of at least a part of a signal band on a longest wavelength side among a plurality of signal bands, and the second Raman amplifier includes a second pumping light source that outputs second pumping light of a specific wavelength for amplifying a second signal band from a shorter wavelength side with highest efficiency among the plurality of signal bands and a second controller that controls the power of the second pumping light source based on a result obtained from the first power detector.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an example of an optical transmission system.

FIG. 2 illustrates an example of a Raman amplification system.

FIG. 3 illustrates a flowchart illustrating an example of operation of the Raman amplification system in accordance with a first embodiment.

FIG. 4A is an example of the power spectrum of the forward-pumped Raman amplification alone.

FIG. 4B is an example of a graph illustrating gain saturation.

FIG. 5 is an example of the power spectrum of the backward-pumped Raman amplification alone.

FIG. 6 is a diagram for explaining an example of the action in accordance with the first embodiment.

FIG. 7 is an example of a Raman gain spectrum.

FIG. 8 is an example of a forward-pumped Raman amplifier in accordance with a second embodiment.

FIG. 9 is an example of a backward-pumped Raman amplifier in accordance with the second embodiment.

FIG. 10 is a flowchart illustrating an example of operation of a Raman amplification system in accordance with the second embodiment.

FIG. 11 is an example of a power spectrum obtained by using both forward and backward Raman amplifications.

FIG. 12 is a diagram for explaining an example of the operation in accordance with the second embodiment.

FIG. 13 is another example of a power spectrum obtained by using both forward and backward Raman amplifications.

FIG. 14 is an example of a graph showing the relationship between a specific center wavelength and flatness of the forward-pumped Raman amplification.

### DESCRIPTION OF EMBODIMENTS

The wavelength band used for the signal light is gradually extended from the viewpoint of securing a large capacity transmission. For this reason, for example, there is a possibility that transmission using two wavelength bands, i.e., a C-band (conventional band) and an L-band (long wavelength band), will be replaced in the future by transmission using four wavelength bands, i.e., an S-band (short wavelength band), the C-band, the L-band, and a U-band (ultra long wavelength band).

In such transmission of four wavelength bands (hereinafter referred to as four bands transmission), in order to secure flatness of the Raman gain for the signal light, it is difficult for the backward-pumped type Raman amplifier to secure a sufficient Raman gain for the signal light of the U-band. More specifically, when the wavelengths of a single pumping light are closer to the shorter wavelengths than the wavelengths of the signal light in the S-band, the Raman gain obtained by the pumping light becomes maximum near the long wavelength side of the pump light, i.e., 13 THz (terahertz). Then, the Raman gain drops sharply when the wavelength exceeds the long wavelength side of the pumping light, i.e., around 15 THz. That is, in such a case, although the Raman gain for the signal light from the S-band to the L-band is secured, the Raman gain for the signal light of the U-band is not secured, and as a result, it becomes difficult to secure the flatness of the Raman gain.

On the other hand, in the case of securing the Raman gain for the signal light in the four bands transmission, in the forward-pumped type Raman amplifier, the Raman gain for the signal light of the L-band and the U-band increases, but the Raman gain for the signal light of the S-band and the C-band decreases due to the influence of the stimulated Raman scattering for the signal light. As described above, even in the case of the forward-pumped type Raman amplifier, it is difficult to secure the flatness of the Raman gain as a result.

Hereinafter, a description will be given of embodiments of the present disclosure with reference to the accompanying drawings.

### First Embodiment

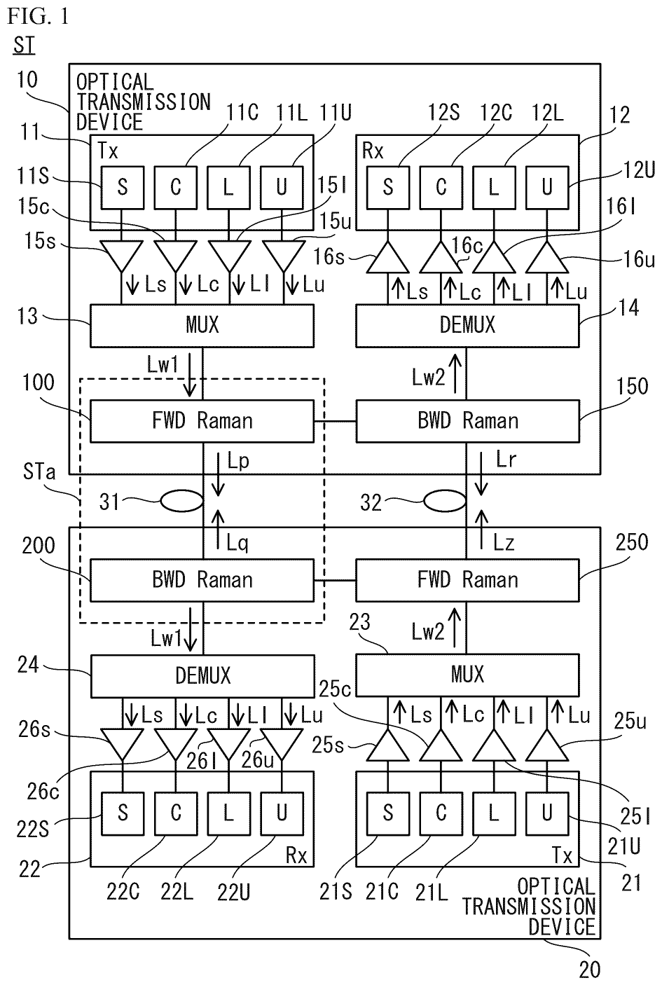

As illustrated in FIG. 1, the optical transmission system ST includes two optical transmission devices 10, 20. The optical transmission devices 10, 20 are, for example, a reconfigurable optical add/drop multiplexer (ROADM). The optical transmission devices 10, 20 may be, for example, an In-Line Amplifier (ILA). The optical transmission devices 10, 20 are connected via two optical transmission lines 31, 32. The optical transmission lines 31, 32 include, for example, an optical fiber. The transmission line type of the optical transmission lines 31, 32 is not particularly limited. For example, the optical transmission lines 31, 32 may include a Single Mode Fiber (SMF). The optical transmission lines 31, 32 may include a Dispersion Shifted Fiber (DSF).

First, the optical transmission device 10 will be described. The optical transmission device 10 includes an optical transmitter (abbreviated as Tx in FIG. 1) 11, an optical receiver (abbreviated as Rx in FIG. 1) 12, a multiplexer (abbreviated as MUX in FIG. 1) 13, and a demultiplexer (abbreviated as DEMUX in FIG. 1) 14. The optical transmission device 10 includes optical amplifiers 15s, 15c, 15l, 15u, 16 s, 16c, 16l, 16u, a forward-pumped Raman amplifier (abbreviated as FWD Raman in FIG. 1) 100, and a backward-pumped Raman amplifier (abbreviated as BWD Raman in FIG. 1) 150.

The optical transmitter 11 includes an S-band transmitter 11S and a C-band transmitter 11C. The optical transmitter 11 includes an L-band transmitter 11L and a U-band transmitter 11U. The S-band transmitter 11S transmits a signal light having a center wavelength belonging to the S-band. The S-band is a wavelength band of, for example, 1460 nm (nanometers) to 1530 nm. The C-band transmitter 11C transmits a signal light having a center wavelength belonging to the C-band. The C-band is a wavelength band of, for example, 1530 nm to 1565 nm. The L-band transmitter 11L transmits a signal light having a center wavelength belonging to the L-band. The L band is a wavelength band of, for example, 1565 nm to 1625 nm. The U-band transmitter 11U transmits a signal light having a center wavelength belonging to the U-band. The U-band is an example of a signal band on the longest wavelength side in the four bands transmission, and is a wavelength band of, for example, 1625 nm to 1675 nm. Therefore, the L-band is an example of the second signal band from the longest wavelength side, the C-band is an example of the third signal band from the longest wavelength side, and the S-band is an example of the fourth signal band from the longest wavelength side. It may be rephrased that the C-band is the second signal band from the short wavelength side.

In this way, the S-band transmitter 11S, the C-band transmitter 11C, the L-band transmitter 11L, and the U-band transmitter 11U transmit signal lights having different wavelength bands. Note that there may be signal lights having different wavelengths in each wavelength band, or transmitters and receivers may be arranged in each wavelength band at the same time, and hereinafter, all signal lights belonging to the S-band, the C-band, the L-band, and the U-band are respectively abbreviated as Wavelength Division Multiplexing (WDM) lights Ls, Lc, Ll, and Lu.

The optical receiver 12 includes an S-band receiver 12S and a C-band receiver 12C. The optical receiver 12 includes an L-band receiver 12L and a U-band receiver 12U. The S-band receiver 12S, the C-band receiver 12C, the L-band receiver 12L, and the U-band receiver 12U receive signal light of different wavelength bands.

The multiplexer 13 multiplexes the WDM lights Ls, Lc, Ll, and Lu having different wavelength bands to generate a WDM light Lw1. The demultiplexer 14 demultiplexes the WDM light Lw2 output from the backward-pumped Raman amplifier 150 into WDM lights Ls, Lc, Ll, and Lu having a center wavelength of a fixed wavelength interval. The multiplexer 13 and the demultiplexer 14 include, for example, a WDM coupler.

The optical amplifiers 15s, 15c, 15l, and 15u amplify the WDM lights Ls, Lc, Ll, and Lu. The optical amplifiers 16s, 16c, 16l, and 16u amplify the WDM lights Ls, Lc, Ll, and Lu. The optical amplifiers 15s, 15c, 15l, 15u, 16s, 16c, 16l, and 16u include, for example, an erbium doped fiber amplifier (EDFA). The forward-pumped Raman amplifier 100 outputs a pumping light Lp to the optical transmission line 31 in the same direction as the WDM light Lw1. The pumping light Lp corresponds to the forward pumping light for the WDM light Lw1. The pumping light Lp enters the optical transmission line 31, which causes introduced stimulated Raman scattering, and thereby, the WDM light Lw1 is Raman-amplified. The backward-pumped Raman amplifier 150 outputs the pumping light Lr to the optical transmission line 32 in the direction opposite to the direction of the WDM light Lw2. The pumping light Lr corresponds to the backward pumping light for the WDM light Lw2. The pumping light Lr enters the optical transmission line 32, which causes introduced stimulated Raman scattering, and thereby, the WDM light Lw2 is Raman-amplified.

Next, the optical transmission device 20 will be described. The optical transmission device 20 includes an optical transmitter 21, an optical receiver 22, a multiplexer 23, and a demultiplexer 24. The optical transmission device 20 includes optical amplifiers 25s, 25c, 25l, 25u, 26s, 26c, 26l, and 26u, a backward-pumped Raman amplifier 200, and a forward-pumped Raman amplifier 250. The backward-pumped Raman amplifier 200 is an example of the first Raman amplifier. The forward-pumped Raman amplifier 100 is an example of the second Raman amplifier.

The optical transmitter 21 has basically the same configuration as the optical transmitter 11 described above and has the same functions, and therefore, a detailed description thereof will be omitted. For example, the optical transmitter 21 includes an S-band transmitter 21S and a C-band transmitter 21C. The optical transmitter 21 includes an L-band transmitter 21L and a U-band transmitter 21U. Therefore, the S-band transmitter 21S, the C-band transmitter 21C, the L-band transmitter 21L, and the U-band transmitter 21U transmit signal lights having different wavelength bands.

The optical receiver 22 has basically the same configuration as the optical receiver 12 described above and has the same functions, and therefore, a detailed description thereof will be omitted. For example, the optical receiver 22 includes an S-band receiver 22S and a C-band receiver 22C. The optical receiver 22 includes an L-band receiver 22L and a U-band receiver 22U. Therefore, the S-band receiver 22S, the C-band receiver 22C, the L-band receiver 22L, and the U-band receiver 22U receive signal light of different wavelength bands.

The optical amplifiers 25s, 25c, 25l, 25u, 26s, 26c, 26l, and 26u have basically the same functions as those of the optical amplifiers 15s, 15c, 15l, 15u, 16s, 16c, 16l, and 16u described above, and therefore, detailed description thereof is omitted. For example, the optical amplifiers 25s, 25c, 25l, and 25u amplify the WDM lights Ls, Lc, Ll, and Lu. The optical amplifiers 26s, 26c, 26l, and 26u amplify the WDM lights Ls, Lc, Ll, and Lu. The backward-pumped Raman amplifier 200 and the forward-pumped Raman amplifier 250 basically have the same functions as those of the backward-pumped Raman amplifier 150 and the forward-pumped Raman amplifier 100 described above, and therefore, detailed description thereof will be omitted. For example, the backward-pumped Raman amplifier 200 outputs a pumping light Lq to the optical transmission line 31 in the direction opposite to the direction of the WDM light Lw1. The pumping light Lq corresponds to the backward pumping light for the WDM light Lw1. The forward-pumped Raman amplifier 250 outputs a pumping light Lz to the optical transmission line 32 in the same direction as the WDM light Lw2. The pumping light Lz corresponds to the forward pumping light for the WDM light Lw2.

Here, the forward-pumped Raman amplifier 100 is connected to the backward-pumped Raman amplifier 200 through the optical transmission line 31. The forward-pumped Raman amplifier 100 is provided on the input side of the optical transmission line 31. The backward-pumped Raman amplifier 200 is provided on the output side of the optical transmission line 31. The forward-pumped Raman amplifier 250 is connected to the backward-pumped Raman amplifier 150 through the optical transmission line 32. The forward-pumped Raman amplifier 250 is provided on the input side of the optical transmission line 32. The backward-pumped Raman amplifier 150 is provided on the output side of the optical transmission line 32.

For example, by using the forward-pumped Raman amplifier 100 and the backward-pumped Raman amplifier 200, a bidirectional pumped Raman amplification system STa for amplifying signal bands can be realized. The Raman amplification system STa may or may not include the optical transmission line 31. Alternatively, a fiber for Raman amplification may be disposed in place of the optical transmission line 31 to realize a Raman amplification system as a concentrated Raman amplification. By using the forward-pumped Raman amplifier 250 and the backward-pumped Raman amplifier 150, a bidirectional pumped Raman amplification system for amplifying signal bands can be realized. Such Raman amplification system may or may not include the optical transmission line 32. Alternatively, the fiber for Raman amplification may be disposed in place of the optical transmission line 32 to realize a Raman amplification system as a concentrated Raman amplification.

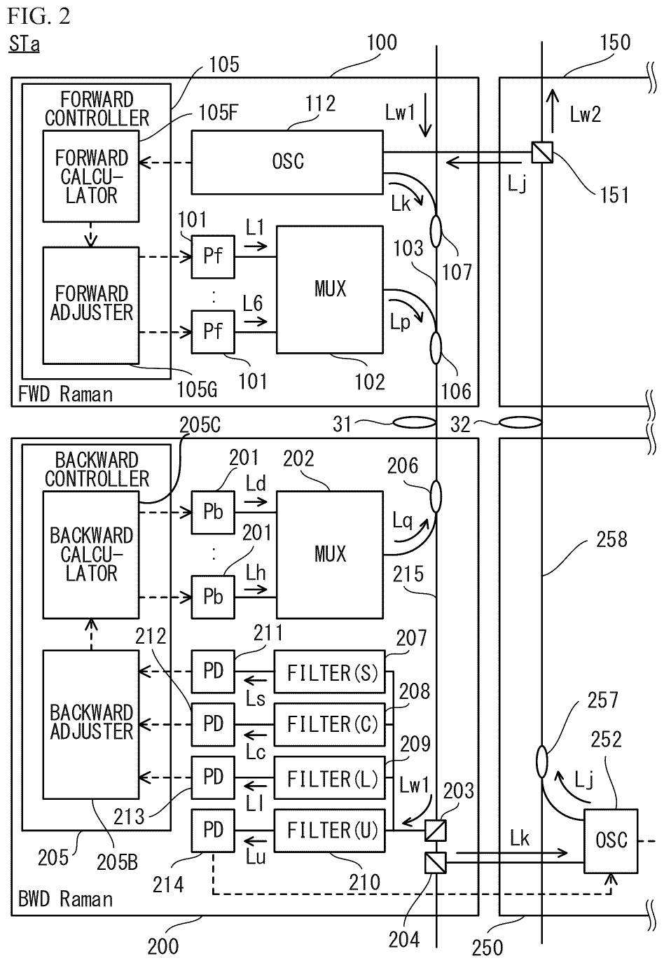

Referring to FIG. 2, the details of the forward-pumped Raman amplifier 100 and the backward-pumped Raman amplifier 200 provided in the Raman amplification system STa will be described.

First, the forward-pumped Raman amplifier 100 will be described. The forward-pumped Raman amplifier 100 includes a plurality of forward pumping light sources 101. For example, the forward-pumped Raman amplifier 100 includes the six forward pumping light sources 101. The forward-pumped Raman amplifier 100 includes a multiplexer 102 and a forward controller 105. Further, the forward-pumped Raman amplifier 100 includes a plurality of WDM couplers 106, 107 and an Optical Supervisory Channel (OSC) communicator 112. The plurality of WDM couplers 106, 107 are provided on an optical waveguide 103. The forward controller 105 is an example of a controller and a second controller.

Each of the forward pumping light sources 101 outputs unit pumping lights L1, . . . , L6 having different center wavelengths. The plurality of the forward pumping light sources 101 outputting the unit pumping light L1, . . . , L6 excluding the unit pumping light L4 are an example of a plurality of third pumping light sources. The unit pumping light L1, . . . , L6 are incoherent pumping light belonging to a wavelength band shorter than the shortest wavelength belonging to the S-band. Therefore, the forward pumping light source 101 corresponds to an example of an incoherent light source. Since the unit pumping lights L1, . . . , L6 are incoherent pumping light, signal degradation caused by Relative Intensity Noise (RIN) is suppressed. The multiplexer 102 multiplexes the unit pumping lights L1, . . . , L6 to generate the pumping light Lp. The pumping light Lp is output to the optical transmission line 31 through the WDM coupler 106. Thus, in the optical transmission line 31, the pumping light Lp amplifies the WDM light Lw1.

The OSC communicator 112 transmits the OSC light Lk. The OSC light Lk is control light for controlling the operation of the forward-pumped Raman amplifier 250. The OSC light Lk is output to the optical transmission line 31 through the WDM coupler 107. The OSC communicator 112 receives the OSC light Lj. The OSC light Lj is control light for controlling the operation of the forward-pumped Raman amplifier 100. The OSC light Lj is input to the OSC communicator 112 from an optical coupler 151 provided in the backward-pumped Raman amplifier 150. The OSC communicator 112 electrically notifies the forward controller 105 of predetermined information contained in the OSC light Lj. Although the details will be described later, the predetermined information is a measured value (hereinafter, referred to as a monitor value) of the optical power of the U-band WDM light Lu.

The forward controller 105 includes a forward calculator 105F and a forward adjuster 105G. The forward calculator 105F individually calculates the adjustment amount used for controlling the optical power of the unit pumping lights L1, . . . , L6 based on the predetermined information notified from the OSC communicator 112. The forward adjuster 105G controls the operations of the plurality of forward pumping light sources 101 based on the adjustment amounts calculated by the forward calculator 105F. Specifically, the forward adjuster 105G controls the optical powers of the unit pumping lights L1, . . . , L6 in a state where the pumping ratio is kept constant or fixed, and adjusts the Raman gain for the WDM light Lu.

Next, the backward-pumped Raman amplifier 200 will be described. The backward-pumped Raman amplifier 200 includes a plurality of backward pumping light sources 201. The plurality of the backward pumping light sources 201 are examples of a plurality of first pumping light sources. For example, the backward-pumped Raman amplifier 200 includes the five backward pumping light sources 201. The number of the backward pumping light sources 201 may be the same as or different from the number of the forward pumping light sources 101.

The backward-pumped Raman amplifier 200 includes a multiplexer 202 and a backward controller 205. The backward-pumped Raman amplifier 200 further includes a plurality of optical couplers 203, 204 and a WDM coupler 206. The optical couplers 203, 204 and the WDM coupler 206 are provided on an optical waveguide 215. The backward controller 205 is an example of a first control unit.

The backward-pumped Raman amplifier 200 includes a plurality of optical filters 207, 208, 209, 210 and a plurality of monitor photo diodes (PDs) 211, 212, 213, 214. The monitor PD 214 is an example of a first detector. The monitor PD 213 is an example of a second detector. The monitor PD 212 is an example of a third detector. The monitor PD 211 is an example of a fourth detector.

Each of the backward pumping light sources 201 outputs unit pumping lights Ld, . . . , Lh having a different center wavelength. The unit pumping lights Ld, . . . , Lh are coherent pumping light belonging to a wavelength band shorter than the shortest wavelength belonging to the S-band. The multiplexer 202 multiplexes the unit pumping lights Ld, . . . , Lh to generate the pumping light Lq. The pumping light Lq is output to the optical transmission line 31 via the WDM coupler 206. Thus, in the optical transmission line 31, the pumping light Lq amplifies the WDM light Lw1.

The optical coupler 203 branches the WDM light Lw1. A part of the WDM light Lw1 is output to the outside of the backward-pumped Raman amplifier 200 through the optical coupler 204. The remainder of the WDM light Lw1 is input to each of the optical filters 207, 208, 209, 210. The optical coupler 204 branches a part of the WDM light Lw1 and the OSC light Lk. The OSC light Lk is output to an OSC communicator 252 provided in the forward-pumped Raman amplifier 250. A part of the WDM light Lw1 is output to the outside of the backward-pumped Raman amplifier 200.

The optical filter 207 allows the WDM light Ls included in the remainder of the WDM light Lw1 to pass through, and blocks the WDM light Lc, Ll, and Lu included in the remainder of the WDM light Lw1 to pass through. The monitor PD 211 detects the WDM light Ls and outputs the magnitude of the optical power of the detected WDM light Ls to the backward controller 205 as an electrical monitor value. The optical filter 208 allows the WDM light Lc contained in the remainder of the WDM light Lw1 to pass through, and blocks the WDM light Ls, Ll, and Lu contained in the remainder of the WDM light Lw1 to pass through. The monitor PD 212 detects the WDM light Lc and outputs the magnitude of the optical power of the detected WDM light Lc to the backward controller 205 as the electrical monitor value.

The optical filter 209 allows the WDM light Ll included in the remainder of the WDM light Lw1 to pass through, and blocks the WDM light Ls, Lc, and Lu included in the remainder of the WDM light Lw1 to pass through. The monitor PD 213 detects the WDM light Ll and outputs the magnitude of the optical power of the detected WDM light Ll to the backward controller 205 as the electrical monitor value. The optical filter 210 allows the WDM light Lu included in the remainder of the WDM light Lw1 to pass through, and blocks the WDM light Ls, Lc, and Ll included in the remainder of the WDM light Lw1 to pass through. The monitor PD 214 detects all of the WDM light Lu and outputs the magnitude of the optical power of the detected WDM light Lu to the OSC communicator 252 as the electrical monitor value.

Thus, the OSC communicator 252 can generate the OSC light Lj including the monitor value output from the monitor PD 214 as predetermined information. That is, the OSC communicator 252 can generate the OSC light Lj including the monitor value of the optical power of the U-band WDM light Lu. When the OSC communicator 252 generates the OSC light Lj, the OSC communicator 252 transmits the OSC light Lj. The OSC light Lj propagates through an optical waveguide 258 via a WDM coupler 257, and is guided to the optical coupler 151 via the optical transmission line 32. The optical coupler 151 branches the WDM light Lw2 and the OSC light Lj and leads the OSC light Lj to the OSC communicator 112. Thus, the OSC communicator 112 can receive the OSC light Lj.

The backward controller 205 includes a backward calculator 205B and a backward adjuster 205C. The backward calculator 205B individually calculates the adjustment amount used for controlling the optical power of the unit pumping lights Ld, . . . , Lh based on each monitor value output from the monitor PDs 211, 212, 213. The backward adjuster 205C controls each operation of the plurality of backward pumping light sources 201 based on each adjustment amount calculated by the backward calculator 205B. Specifically, the backward adjuster 205C controls the optical power of the unit pumping lights Ld, . . . , Lh, and adjusts the Raman gain for each WDM light Ls, Lc, Ll.

The technique for adjusting the Raman gain for each of the WDM lights Ls, Lc, and Ll can be referred to, for example, a patent document (e.g., Japanese Patent No. 4821037) in which the C-band is branched into a plurality of bands to adjust the Raman gain. For example, based on the patent document, the backward controller 205 can calculate the above-described adjustment amount based on the each monitor value output from the monitor PD 211, 212, 213 and the inverse matrix of the average gain coefficient.

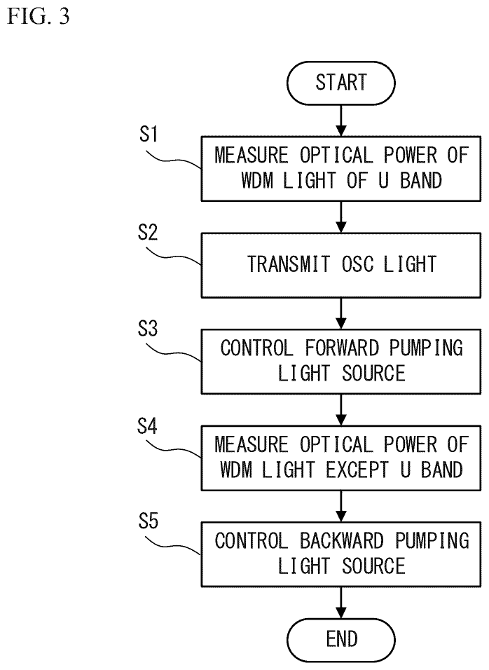

Referring to FIG. 3, the operation of the Raman amplification system STa in accordance with the first embodiment will be described.

First, the monitor PD 214 measures the optical power of the U-band WDM light (step S1). That is, the monitor PD 214 measures the magnitude of the optical power of the WDM light Lu. When the monitor PD 214 measures the optical power of the U-band WDM light, the OSC communicator 252 transmits the OSC light Lj (step S2). More specifically, the OSC communicator 252 transmits the OSC light Lj including the magnitude of the optical power of the WDM light Lu measured by the monitor PD 214 as a monitor value to the OSC communicator 112.

When the OSC communicator 252 transmits the OSC light Lj, the forward adjuster 105G controls the forward pumping light source 101 (step S3). More specifically, the forward adjuster 105G adjusts the optical powers of the unit pumping lights L1, . . . , L6 in a state where the pumping ratio is fixed, based on the respective adjustment amounts calculated by the forward calculator 105F.

When the forward adjuster 105G controls the forward pumping light source 101, the monitor PD 211, 212, 213 measure the optical power of the WDM light other than the U-band light (step S4). That is, the monitor PD 211, 212, 213 measure the magnitude of the optical power of each of the WDM lights Ls, Lc, and Ll. When the monitor PD 211, 212, 213 measure the optical power of the WDM light other than the U-band light, the backward adjuster 205C controls the backward pumping light source 201 (step S5), and the process ends. More specifically, the backward adjuster 205C adjusts the optical power of the unit pumping lights Ld, . . . , Lh based on the adjustment amounts calculated by the backward calculator 205B.

As described above, the Raman amplification system STa in accordance with the first embodiment adjusts the Raman gain for the WDM light Ls, Lc, and Ll after adjusting the Raman gain for the WDM light Lu. In particular, the Raman amplification system STa in accordance with the first embodiment controls the optical power of the pumping light Lq based on the optical power of each of the WDM lights Ls, Lc, and Ll, and adjusts the Raman gain for the WDM lights Ls, Lc, and Ll. This enables the Raman amplification system STa to secure the flatness of the Raman gain in the transmission of four wavelength bands, i.e., the S-band, the C-band, the L-band, and the U-band.

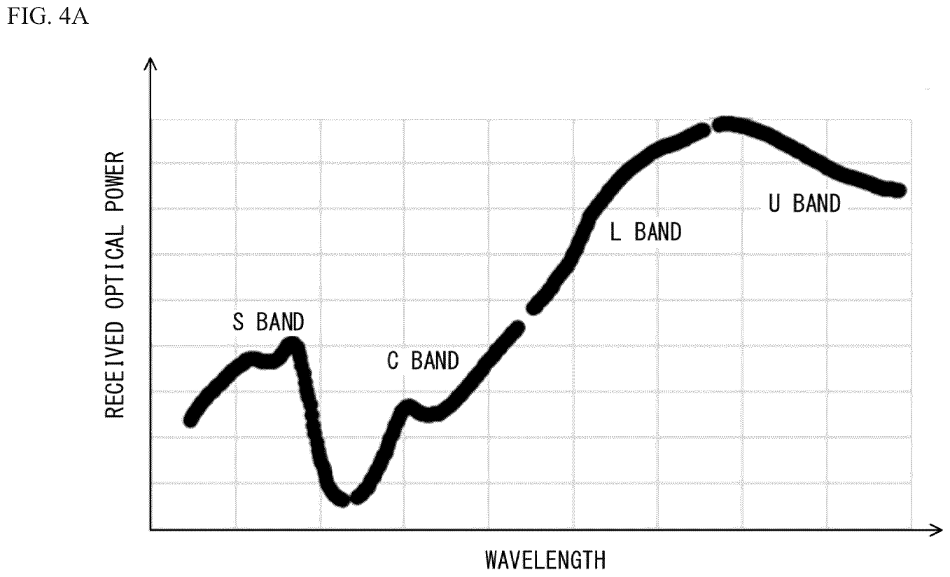

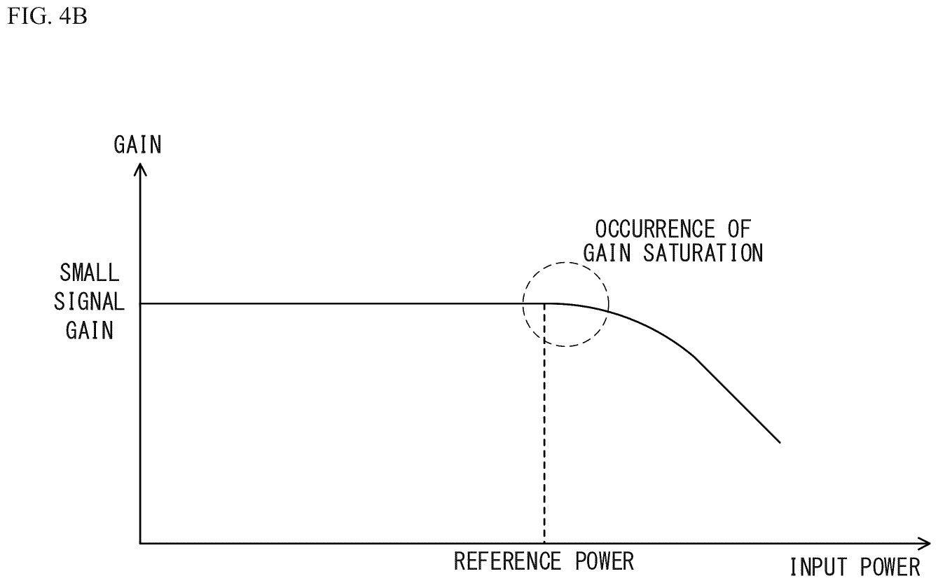

Referring to FIGS. 4A to 7, the operation and effect of the Raman amplification system STa in accordance with the first embodiment will be described.

For example, when the forward-pumped Raman amplifier 100 independently Raman-amplifies the WDM light Lw1, the forward-pumped Raman amplification appears most prominently in the vicinity of the input where the WDM light Lw1 is input to the optical transmission line 31. Therefore, the input power, which is the optical power when the WDM light Lw1 is input to the optical transmission line 31, becomes high, and therefore, the saturation of the gain is likely to occur, and it is difficult to secure a large gain.

The saturation of the gain means a phenomenon that a constant gain can be secured as a small signal gain when the input power is lower than a predetermined reference power, but the gain is gradually limited to a gain lower than the small signal gain as the input power becomes higher when the input power is higher than the reference power, as illustrated in FIG. 4B. As described above, when the forward-pumped Raman amplifier 100 independently Raman-amplifies the WDM light Lw1, the saturation of the gain is likely to occur, and it is difficult to secure a large gain.

When the WDM light Ls, Lc, Ll, and Lu are included in the WDM light Lw1, the stimulated Raman scattering between the WDM lights Ls, Lc, Ll, and Lu included in the WDM light Lw1 becomes significant, and the Raman gain changes in the entire wavelength band from the S-band to the U-band. That is, the optical power on the short wavelength side such as the S-band or the C-band is shifted to the long wavelength side such as the L-band or the U-band, so that the gain on the short wavelength side cannot be sufficiently obtained.

As a result, as illustrated in FIG. 4A, in the power spectrum of the received optical power (or reception level) which is the optical power of each of the WDM lights Ls, Lc, Ll, and Lu received by the optical receiver 22, the received optical power on the short wavelength side becomes smaller than the received optical power on the long wavelength side. As described above, when the forward-pumped Raman amplifier 100 independently Raman-amplifies the WDM light Lw1 without using the backward-pumped Raman amplifier 200, it becomes difficult to secure the flatness of the power spectrum.

On the other hand, when the backward-pumped Raman amplifier 200 Raman-amplifies the WDM light Lw1, the backward-pumped Raman amplification appears most prominently in the vicinity of the output where the WDM light Lw1 is output from the optical transmission line 31. In this case, since the WDM light Lw1 has already propagated through the optical transmission line 31, the input power of the WDM light Lw1 is reduced due to the transmission line loss, and the occurrence of the saturation of the gain is suppressed. That is, when the backward-pumped Raman amplifier 200 Raman-amplifies the WDM light Lw1, a large gain can be secured.

However, when the backward-pumped Raman amplifier 200 independently Raman amplifies the WDM light Lw1, the wavelength band in which the Raman gain can be secured is limited. For example, the wavelength band in which the Raman gain can be secured is limited to three wavelength bands of the S-band, the C-band, and the L-band. That is, there is a case where the Raman gain for the U-band is not secured. Here, each pumping wavelength of the plurality of unit pumping lights used for Raman amplification is shorter than the shortest wavelength of the WDM light Ls. Therefore, for example, the Raman gain of the unit pumping light having the longest pumping wavelength reaches a peak at the long wavelength side of 13 THz, that is, near the wavelength of the WDM light Ll, and decreases sharply when the wavelength exceeds 15 THz. That is, there is a high possibility that the Raman gain for the WDM light Lu is not secured.

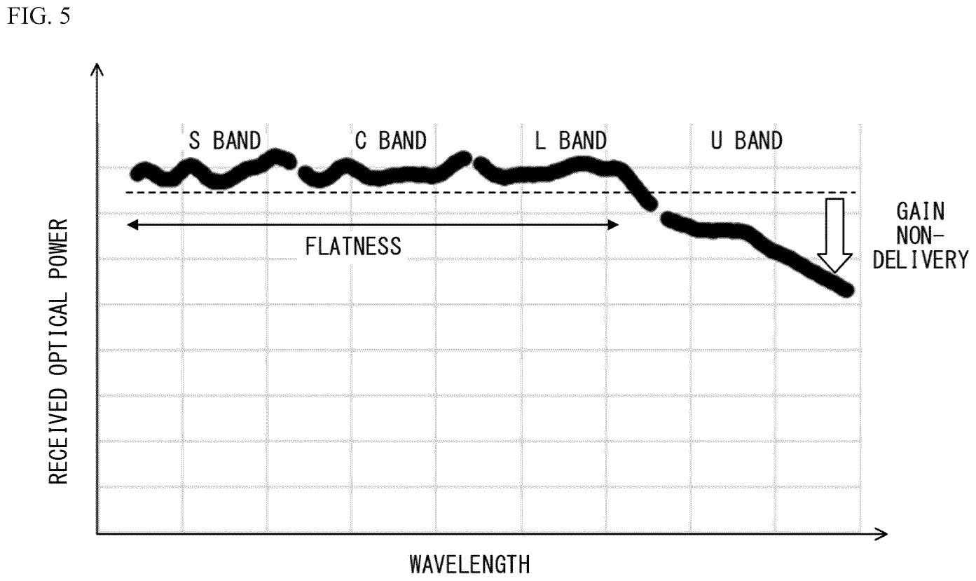

As a result, as illustrated in FIG. 5, the power spectrum of the received optical power, which is the optical power of each of the WDM lights Ls, Lc, Ll, and Lu received by the optical receiver 22, is kept flat except for the received optical power of the WDM light Lu. That is, the Raman gain does not reach the WDM light Lu, and the flatness is secured only for each optical power of the WDM light Ls, Lc, and Ll. As described above, even if the backward-pumped Raman amplifier 200 independently Raman-amplifies the WDM light Lw1 without using the forward-pumped Raman amplifier 100, it is difficult to secure the flatness of the power spectrum in the four bands transmission.

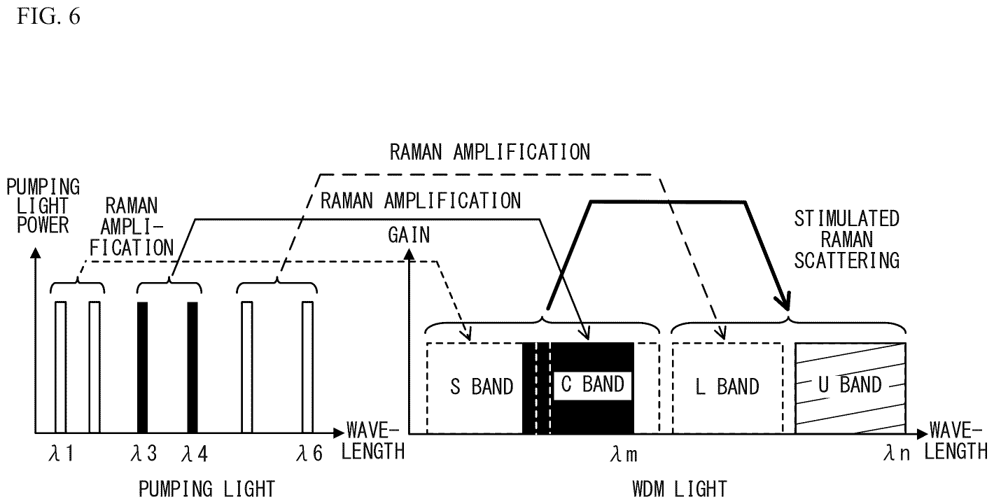

In the present embodiment, however, first, the forward-pumped Raman amplifier 100 amplifies the optical power of the WDM lights Ls, Lc, Ll by Raman amplification, as illustrated in FIG. 6. On the other hand, as the WDM light Lw1 including the WDM lights Ls, Lc, Ll, and Lu propagates, stimulated Raman scattering occurs. As a result, the optical powers of the WDM lights Ls and Lc are shifted to the optical powers of the WDM lights Ll and Lu, and the optical powers of the WDM lights Ll and Lu are increased compared with the optical powers of the WDM lights Ls and Lc. As a result, the Raman gain of the U-band is sufficiently secured.

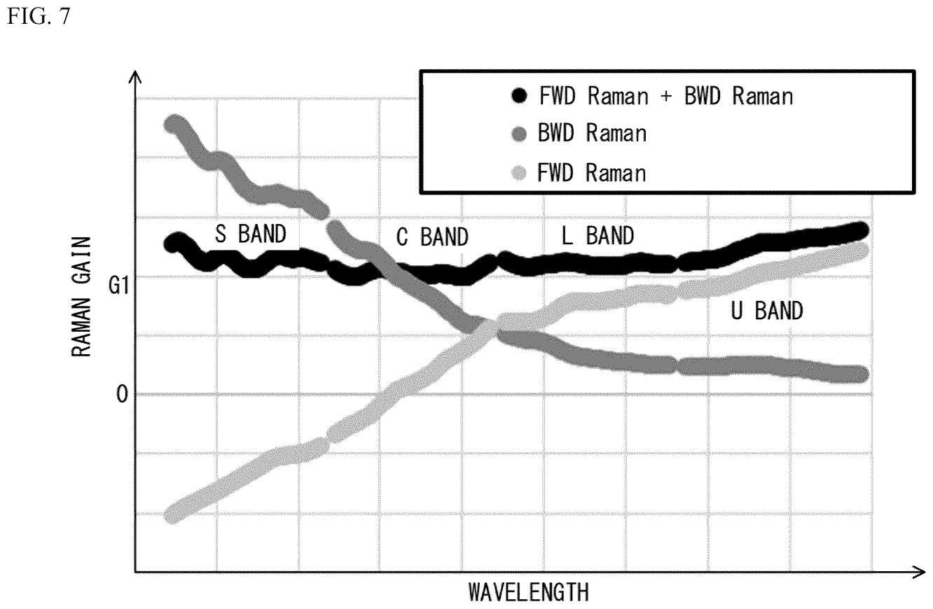

Next, the backward-pumped Raman amplifier 200 amplifies the optical power of the WDM light Ls, Lc, Ll by Raman amplification. In this case, the influence of stimulated Raman scattering is negligibly small. As a result, the Raman gain is sufficiently secured only in the S-band, the C-band, and the L-band. By thus using the forward-pumped and backward-pumped Raman amplifiers 100, 200 together and specifying the order of adjusting the Raman amplification gain, the Raman amplification system STa can secure a flat Raman gain G1 as illustrated in FIG. 7.

### Second Embodiment

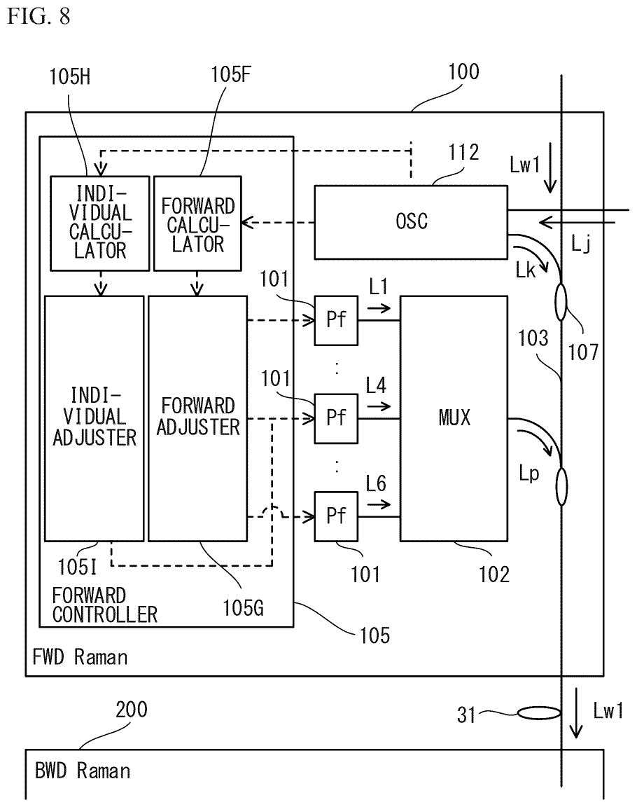

A second embodiment of the present invention will be described with reference to FIGS. 8 to 14. The same components as those of the forward-pumped Raman amplifier 100 and the backward-pumped Raman amplifier 200 in accordance with the first embodiment are basically denoted by the same reference numerals, and detailed description thereof will be omitted.

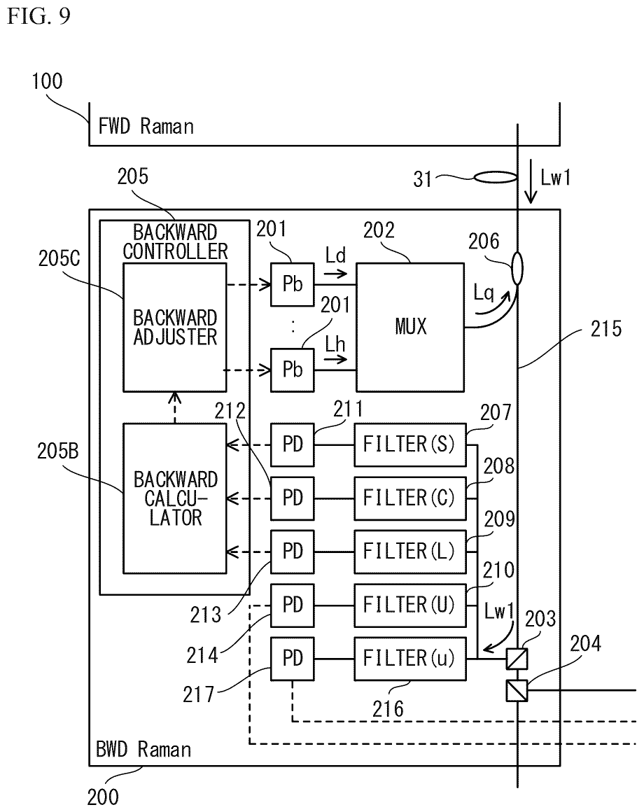

As illustrated in FIG. 8, in the forward-pumped Raman amplifier 100 in accordance with the second embodiment, the forward controller 105 further includes an individual calculator 105H and an individual adjuster 105I. As described above, the forward-pumped Raman amplifier 100 in accordance with the second embodiment is different from the forward-pumped Raman amplifier 100 in accordance with the first embodiment. As illustrated in FIG. 9, the backward-pumped Raman amplifier 200 in accordance with the second embodiment further includes an optical filter 216 and a monitor PD 217. The monitor PD 217 is an example of a first detector. That is, in the second embodiment, both of the monitor PDs 214, 217 correspond to the first detector. As described above, the backward-pumped Raman amplifier 200 in accordance with the second embodiment is different from the backward-pumped Raman amplifier 200 in accordance with the first embodiment.

Here, the optical filter 216 allows a part of the WDM light Lu included in the remainder of the WDM light Lw1 to pass through, described in the first embodiment, and blocks the WDM lights Lc, Ll, and Lu included in the remainder of the WDM light Lw1 and the remainder of the WDM light Lu. Although the details will be described later, the optical filter 216 allows the WDM light Lu from the predetermined wavelength λx to the longest wavelength λy belonging to the U-band to pass through. On the other hand, the optical filter 216 blocks the WDM light Lu from the shortest wavelength λz belonging to the U-band to the predetermined wavelength λx to pass through. The difference between the predetermined wavelength λx and the longest wavelength λy is about several nanometers.

In this way, the optical filter 216 allows a part of the WDM light Lu included in the remainder of the WDM light Lw1 to pass through, described in the first embodiment, and blocks the WDM lights Lc, Ll, and Lu included in the remainder of the WDM light Lw1 and the remainder of the WDM light Lu to pass through. Therefore, the optical filter 210 in accordance with the second embodiment allows the remainder of the WDM light Lu to pass through, and blocks the WDM light Lc, Ll, and Lu included in the remainder of the WDM light Lw1 and a part of the WDM light Lu to pass through.

The monitor PD 217 detects a part of the WDM light Lu described above, and outputs the magnitude of the optical power of the detected part of the WDM light Lu to the OSC communicator 252 (not illustrated in FIG. 9) as an electrical monitor value. In this way, the monitor PD 217 is different from the monitor PD 214 that detects all of the WDM light Lu. That is, the monitor PD 214 in accordance with the second embodiment detects all of the WDM light Lu and outputs the magnitude of all of the optical powers of the detected WDM light Lu as the electrical monitor value to the OSC communicator 252 (not illustrated in FIG. 9).

Thus, the OSC communicator 252 can generate the OSC light Lj including each monitor value output from the monitor PDs 214,217 as predetermined information. That is, the OSC communicator 252 can generate the OSC light Lj including the monitor value of the optical power of a part of the U-band WDM light Lu and the monitor value of the optical power of the entire U-band WDM light Lu. When the OSC communicator 252 generates the OSC light Lj, the OSC communicator 252 transmits the OSC light Lj. Thus, as illustrated in FIG. 8, the OSC communicator 112 can receive the OSC light Lj as in the first embodiment.

The forward calculator 105F and the individual calculator 105H individually calculate the adjustment amounts used for controlling the optical powers of the unit pumping lights L1, . . . , L6 based on the predetermined information notified from the OSC communicator 112. Specifically, the forward calculator 105F individually calculates an adjustment amount used for controlling the optical power of the unit pumping light L1, . . . , L6 excluding the unit pumping light L4, for example, based on the monitor value of all the optical powers of the U-band WDM light Lu. The individual calculator 105H calculates an adjustment amount used for controlling the optical power of the unit pumping light L4 based on the monitor value of the optical power of a part of the U-band WDM light Lu. The forward pumping light source 101 that outputs the unit pumping light L4 is an example of the second pumping light source.

The forward adjuster 105G controls the operations of a plurality of the corresponding forward pumping light sources 101 based on the adjustment amounts calculated by the forward calculator 105F. Specifically, the forward adjuster 105G controls the optical powers of the unit pumping lights L1, . . . , L6 except for the unit pumping light L4 in a state where the pumping ratio is fixed, and adjusts the Raman gain for the remainder of the WDM light Lu. The individual adjuster 105I controls the operation of the corresponding forward excitation light source 101 based on the adjustment amount calculated by the individual calculator 105H. Specifically, the individual adjuster 105I controls the optical power of the unit pumping light L4 and adjusts the Raman gain for a part of the WDM light Lu.

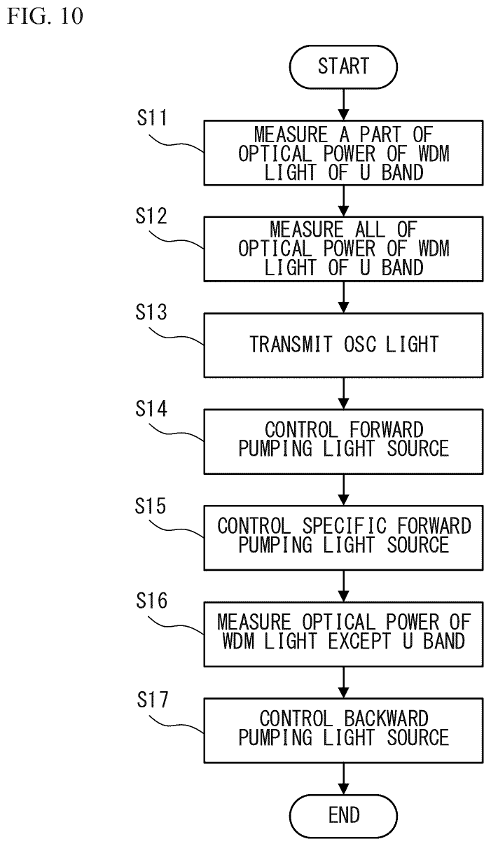

Referring to FIG. 10, the operation of the Raman amplification system STa in accordance with the second embodiment will be described.

First, the monitor PD 217 measures the optical power of a part of the U-band WDM light (step S11). That is, the monitor PD 217 measures the magnitude of the optical power of a part of the WDM light Lu. When the monitor PD 217 measures the optical power of the U-band WDM light, the monitor PD 214 measures the total optical power of the U-band WDM light (step S12). That is, the monitor PD 214 measures the magnitude of the total optical power of the WDM light Lu.

When the monitor PD 214 measures the total optical power of the U-band WDM light, the OSC communicator 252 transmits the OSC light Lj (step S13). More specifically, the OSC communicator 252 transmits the OSC light Lj including the magnitude of the optical power of a part of the WDM light Lu measured by the monitor PD 217 as a monitor value and including the magnitude of the optical power of the entire WDM light Lu measured by the monitor PD 214 as the monitor value to the OSC communicator 112.

When the OSC communicator 252 transmits the OSC light Lj, the forward adjuster 105G controls the forward pumping light source 101 (step S14). More specifically, the forward adjuster 105G adjusts the optical powers of the unit pumping lights L1, . . . , L6 in a state where the pumping ratio is fixed, based on the respective adjustment amounts calculated by the forward calculator 105F. When the forward adjuster 105G controls the forward pumping light source 101, the individual adjuster 105I controls a specific forward pumping light source 101 (step S15). More specifically, the forward adjuster 105G adjusts the optical power of the unit pumping light L4 based on the adjustment amount calculated by the forward calculator 105F.

When the individual adjuster 105I controls the specific forward pumping light source 101, the monitor PDs 211, 212, 213 measure the optical power of the WDM light other than the U-band light (step S16). That is, the monitor PDs 211, 212, 213 measure the magnitude of the optical power of each of the WDM lights Ls, Lc, and Ll. When the monitor PDs 211, 212, 213 measure the optical power of the WDM light other than the U-band light, the backward adjuster 205C controls the backward pumping light source 201 (step S17), and the process ends. More specifically, the backward adjuster 205C adjusts the optical power of the unit pumping lights Ld, . . . , Lh based on each adjustment amount calculated by the backward calculator 205B.

In this way, the Raman amplification system STa in accordance with the second embodiment individually adjusts the Raman gains for a part of the WDM light Lu and all of the WDM light Lu, and then adjusts the Raman gains for the WDM lights Ls, Lc, and Ll. In particular, the Raman amplification system STa in accordance with the first embodiment controls the optical power of the pumping light Lq based on the optical power of each of the WDM lights Ls, Lc, and Ll, and adjusts the Raman gain for the WDM lights Ls, Lc, and Ll. This enables the Raman amplification system STa to secure the flatness of the Raman gain in the transmission of four wavelength bands, i.e., the S-band, the C-band, the L-band, and the U-band.

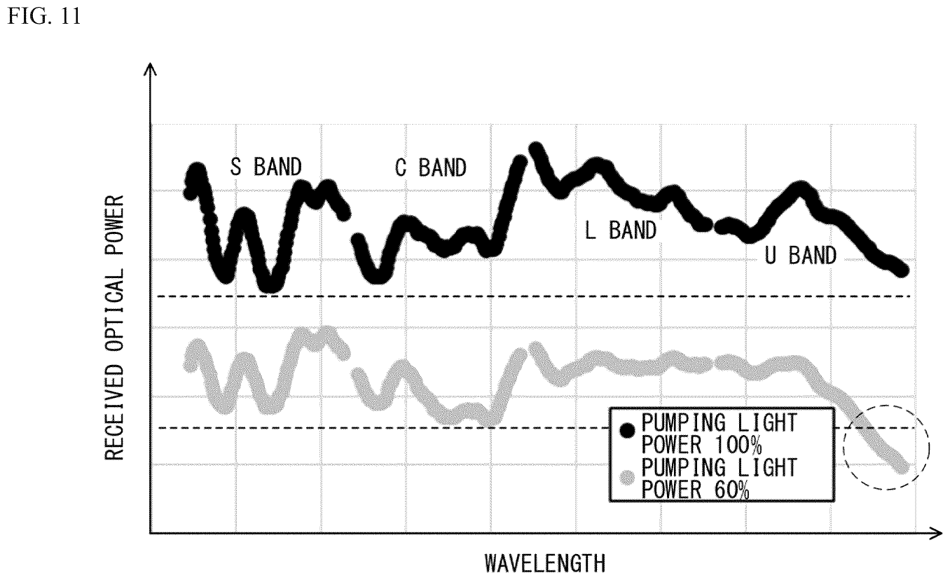

Referring to FIGS. 11 to 14, the operation and effect of the Raman amplification system STa in accordance with the second embodiment will be described.

For example, in the first embodiment described above, the unit pumping light L1, . . . , L6 is output at 100% pumping light power. This secures the desired Raman gain even if the span loss is large. As a result, as illustrated in FIG. 11, in the power spectrum of the received optical power which is the optical power of each of the WDM lights Ls, Lc, Ll, and Lu received by the optical receiver 22, the magnitude of the received optical power is approximately the same when the received optical power on the short wavelength side is compared with the received optical power on the long wavelength side. This ensures the flatness of the received optical power.

However, the span loss may be small depending on the distance of the optical transmission lines 31, 32. In this case, it is sufficient to secure a Raman gain smaller than the desired Raman gain. That is, the unit pumping lights L1, . . . , L6 may be adjusted to pumping light power lower than the desired Raman gain (assuming pumping light power of 100%). For example, the pump optical power of the unit pumping lights L1, . . . , L6 may be adjusted to 55%, 60%, 65%, or the like. However, in this case, as illustrated in FIG. 11, in the power spectrum of the received optical power which is the optical power of each of the WDM lights Ls, Lc, Ll, and Lu received by the optical receiver 22, when the received optical power on the short wavelength side is compared with the received optical power on the long wavelength side, the magnitude of the received optical power does not fall within the same range. Specifically, the received optical power on the long wavelength side drops below the received optical power on the short wavelength side, and the flatness of the light power is lost.

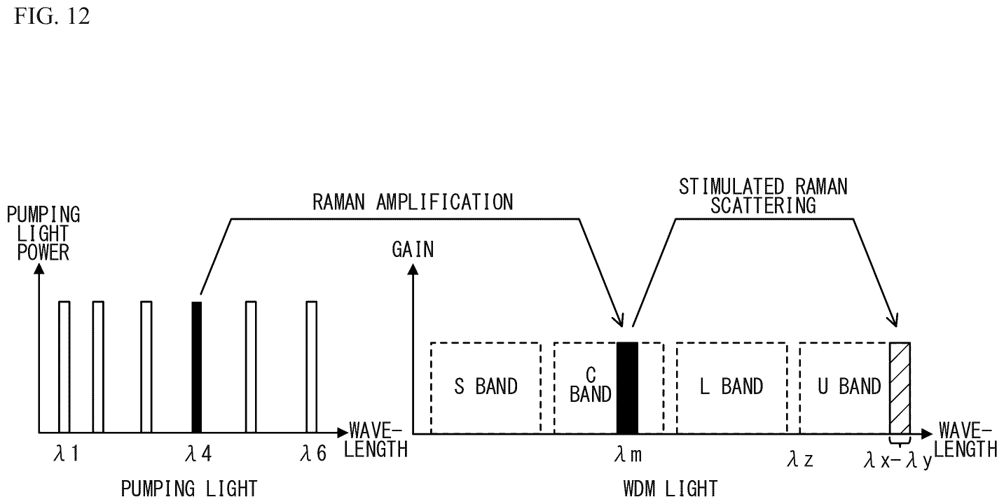

Therefore, as illustrated in FIG. 12, the individual adjuster 105I may independently adjust the pumping light power of the unit pumping light L4 having the specific center wavelength λ4 longer than the center wavelength λ1 of the unit pumping light L1 and shorter than the center wavelength λ6 of the unit pumping light L6, for example. That is, the individual adjuster 105I may adjust the pumping light power of the unit pumping light L4 independently of the fixing of the pumping ratio described above. The specific center wavelength λ4 is an example of a specific wavelength, and is a wavelength which is separated from the longest wavelength λy belonging to the U band by a unit wavelength range toward the short wavelength side. The unit wavelength range is from 190 nm to 210 nm, including 200 nm. The unit wavelength range may be from 195 nm to 205 nm.

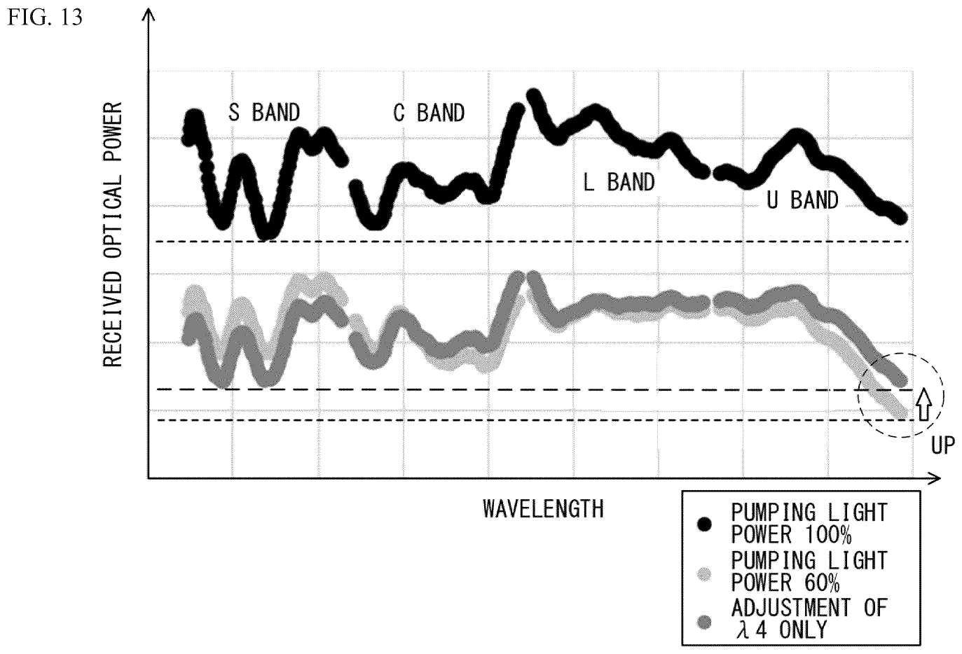

The unit pumping light L4 having the specific center wavelength λ4 amplifies the second signal band having the shortest wavelength among the four signal bands with the highest conversion efficiency. In particular, the WDM light Lc having a center wavelength λm which is about 100 nm longer than the specific center wavelength λ4 is Raman-amplified. The optical power of the WDM light Lc thus Raman-amplified is shifted to the longer wavelength side by stimulated Raman scattering. Thus, the WDM light Lu from the predetermined wavelength λx to the longest wavelength λy belonging to the U-band is amplified. As a result, as illustrated in FIG. 13, the received optical power on the long wavelength side is increased to the same level as the received optical power on the short wavelength side, and the flatness of the received optical power is secured.

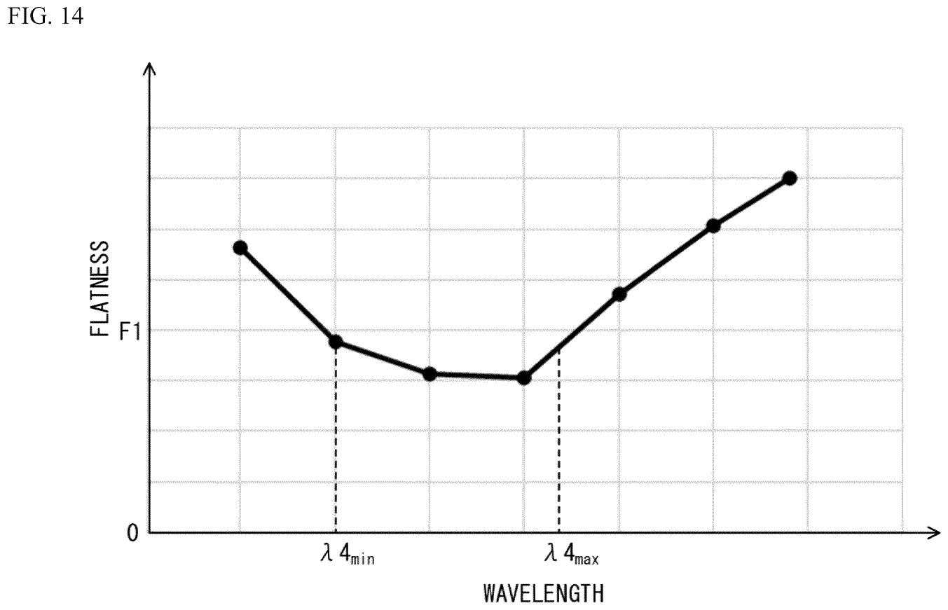

The specific center wavelength λ4 may be included in the range from the minimum center wavelength λ4ₘᵢₙ to the maximum center wavelength λ4ₘₐₓ as illustrated in FIG. 14. The minimum center wavelength λ4ₘᵢₙ is, for example, 1445 nm, and the maximum center wavelength λ4ₘₐₓ is, for example, 1457 nm. If the specific center wavelength λ4 is included in the range from the minimum center wavelength λ4ₘᵢₙ to the maximum center wavelength λ4ₘₐₓ, the received optical power is suppressed to be less than the flatness F1 (for example, 2 dB or the like).

Although the preferred embodiments of the present invention have been described above in detail, the present invention is not limited to the specific embodiments, and various modifications and changes are possible within the scope of the gist of the present invention described in the claims.

What is claimed is:

1. A Raman amplification system comprising:
a first Raman amplifier of a backward-pumped type, which is provided on an output side of a transmission line; and
a second Raman amplifier of a forward-pumped type, which is provided on an input side of the transmission line, wherein
the Raman amplification system amplifies a plurality of signal bands by using the first Raman amplifier and the second Raman amplifier,
the first Raman amplifier includes a first power detector that detects power of at least a part of a signal band on a longest wavelength side among a plurality of signal bands, and
the second Raman amplifier includes a second pumping light source that outputs second pumping light of a specific wavelength for amplifying a second signal band from a shorter wavelength side with highest efficiency among the plurality of signal bands and a second controller that controls the power of the second pumping light source based on a result obtained from the first power detector.

2. The Raman amplification system according to claim 1, wherein
the first power detector of the first Raman amplifier detects power of an entire signal band on the longest wavelength side among the plurality of signal bands of the plurality of bands,
the second Raman amplifier further has a plurality of third pumping light sources each outputting third pumping light of a plurality of different wavelengths excluding the specific wavelength, and
the second controller adjusts power of the second pumping light source and power of the plurality of third pumping light sources based on a result obtained from the first power detector before controlling power of the second pumping light source.

3. The Raman amplification system according to claim 1, wherein the first Raman amplifier further comprises
a plurality of first pumping light sources that output a plurality of first pumping lights having different wavelengths respectively;
a second power detector that monitors the power of an entire second signal band from the longest wavelength side among the plurality of signal bands;
a third power detector that monitors the power of an entire third signal band from the longest wavelength side among the plurality of signal bands;
a fourth power detector that monitors the power of an entire fourth signal band from the longest wavelength side among the plurality of signal bands; and
a first controller that controls the first pumping light sources based on results obtained from the second power detector, the third power detector, and the fourth power detector after the second controller controls the power of the second pumping light source.

4. The Raman amplification system according to claim 1, wherein a center wavelength of the second pumping light source belongs within a range of 1445 nm to 1457 nm.

5. The Raman amplification system according to claim 1, wherein the second pumping light source is an incoherent light source.

6. The Raman amplification system according to claim 1, wherein the signal band on the longest wavelength side is a U-band.

7. A Raman amplification method comprising:
propagating second pumping light of a specific wavelength in a same direction as a signal light, the second pumping light performing Raman amplification on a second signal band from a short wavelength side with highest efficiency among a plurality of signal bands; and
adjusting power of the second pumping light based on power of at least a part of the signal band on a longest wavelength side among the plurality of signal bands.

8. The Raman amplification method according to claim 7, wherein the adjusting includes
adjusting the power of the second pumping light and the power of a plurality of third pumping lights having different wavelengths except for the specific wavelength respectively based on the power of an entire signal band on the longest wavelength side among the plurality of signal bands of the plurality of bands, the plurality of third pumping lights propagating in the same direction as the signal light, and
adjusting the power of a plurality of first pumping lights having different wavelengths respectively based on the power of the remaining signal band except for the signal band on the longest wavelength side among the plurality of signal bands of the plurality of bands, the plurality of first pumping lights propagating in the opposite direction to the signal light.

9. A Raman amplifier for amplifying a plurality of signal bands, the Raman amplifier being provided on an input side of a transmission line, comprising:
a pumping light source that outputs pumping light of a specific wavelength for amplifying a second signal band from a short wavelength side with highest efficiency among the plurality of signal bands; and
a controller that controls power of the pumping light source based on the power of at least a part of the signal band on the longest wavelength side among the plurality of signal bands.
